(19) United States
(12) Patent Application Publication
(10) Pub. No.: US 2024/0143421 A1
(43) Pub. Date: May 2, 2024

(54) Event Recording and Notification Architectures

(71) Applicant: SiFive, Inc., San Mateo, CA (US)

(72) Inventor: Cameron Mcnairy, Fort Collins, CO (US)

(21) Appl. No.: 18/497,213

(22) Filed: Oct. 30, 2023

Related U.S. Application Data
(60) Provisional application No. 63/420,629, filed on Oct. 30, 2022.

(51) Int. Cl. G06F 9/54

(52) U.S. Cl. CPC G06F 9/542

(57) ABSTRACT

Systems and methods are disclosed for event recording and notification. For example, an integrated circuit (e.g., a processor) for executing instructions includes multiple event reporting circuitries that are each configured to store context data for one or more detected events, including an event identifier; an event map circuitry configured to control one or more notification channels based on an input event identifier; and an event summarization circuitry configured to: receive event identifiers from a plurality of child nodes, wherein each child node is one of the reporting circuitries or another event summarization circuitry configured to output an event identifier from one of the event reporting circuitries; select a highest priority event identifier from a set of event identifiers currently output by the plurality of child nodes; output the selected event identifier to the event map circuitry; and store a pointer to the child node that output the selected event identifier.

### CROSS-REFERENCE TO RELATED APPLICATION(S)

This application claims priority to and the benefit of U.S. Provisional Patent Application Ser. No. 63/420,629, filed Oct. 30, 2022, the entire disclosure of which is hereby incorporated by reference.

### TECHNICAL FIELD

This disclosure relates to event recording and notification architectures.

### BACKGROUND

In some computing environments, reliability in a system must be maintained at a high level as compared to typical computing environments, such as personal computers. For example, in some applications, such as applications involving Automotive Safety Integrity Level D (ASIL D), referring to a classification of hazard defined within ISO 26262 (“Road vehicles—Functional safety”), performance may be sacrificed to maintain reliability at a required level.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a system for enabling event recording and notification.

FIGS. 2A-2C are block diagrams of examples of tree topologies for enabling event recording and notification.

FIG. 3 is a block diagram of an example of a tree topology for event recording and notification.

FIG. 4 is a block diagram of an example of a tree topology for event recording and notification with a localized event mapping circuitry taps the tree topology at a lower level to facilitate a potentially faster localized response.

FIG. 5 is a flow chart of an example of a process for event recording and notification.

FIG. 6 is a flow chart of an example of a process for controlling one or more notification channels based on an input event identifier.

FIG. 7 is a flow chart of an example of a process for traversing a tree topology to access context data for an event corresponding to an event identifier output by the tree.

FIG. 8 is a block diagram of an example of a system for facilitating generation of a circuit representation.

### DETAILED DESCRIPTION

### Overview

Systems and methods are described herein that may be used to implement recording and notification of events in integrated circuits. Some implementations of event record and notification may be tailored to fault-tolerance but applicable to a multitude of other situations where an event occurs and notification of the event occurrence along with information about available responses and how to obtain additional details regarding the event are communicated to an agent interested in the event. For example, the events may be errors detected by various components of a system on a chip (SOC) and notifications may be provided to agents of the SOC, such as system software running on a processor core of the SOC (e.g., low level agents, virtual machine agents, operating system agents, or application agents) or a hardware response circuitry configured to respond to a particular type of error. The agent, once notification is received, seeks to assess the who, what, where, when, and why of the event to formulate an appropriate response. For example, an agent may select a response from among predetermined or event record-based suggestions. Some implementations include one or more of an event record facility, an event communication facility, and an event notification summarization facility, and an event notification to signal map facility.

The event record facility records event details, as configured to record, such as who, what, where, when, and why of an event. A portion of these details are then used for the notification of the event to the responding agent. This notification may support a multitude of priorities or importance associated with the event. The event recording facility may support a multitude of events and/or a multitude of resources to record details about the event(s) recorded. The record may be equivalent in format for each event recorded, but unique for the key details of who, what, where, when, and why details of the event or in the available responses supported. Additional information may be implied but is not required to successfully understand and process the details of the event in the record. The event record resources may be visible directly or via a window where only the top few important events are visible. Regardless of the window size (full or minimal) details of the event notifications associated with the event records may be readily available to efficiently provide an overall picture of the event state of the system. The event record may be augmented with unique identifiers to enable resolution of instances among a group of identical events and event recording structures. The event recording typically relies on the detailed information provided by the associated hardware to simply record the event. However, sometimes an event's default values should be overridden or further modified based on specific agent or hardware requirements. An event recording facility may provide a configuration modifier to override the information provided when it meets certain criteria. In some implementations, event information includes its notification information. However, the configuration may be expanded to any part of the recorded who, what, where, when or why for the event. More complex modification capabilities are also possible to track, filter, and count an event in various ways such as occurrence rate. The results of the track, filter, and count may even synthesize an additional event to be recorded. The event recording facility also provides an interlock capability to ensure that new event information is not overwritten when it occurs after a write to invalidate a record is issued.

The event notification may be summarized and coalesced, even reduced, at various places in the solution according to the capacity and event distribution requirements of the system. The reduction may be from many to few with many being one and few also being one in an extreme example. The event notification property may be used to identify the most important event notification and may even choose to propagate only a portion of the most important event notifications received. This reduction may retain information about the history of the event notifications seen at the reduction point and provide information on how to directly access the event notifications that are reduced. An event notification topology may be a single tree, multiple trees, or even a ring based on the needs and desired capability of the event notification solution.

An event notification may be mapped to an agent response notification. The agent processes portions of the event notification and agent response to determine how to access the event record to obtain further details of the event and formulate an appropriate response. The map function may also record a history of the recent notifications and may provide configuration for which notifications to intercept and map to notifications or to pass on without action. The map may also include configuration to dynamically or statically amplify or mute event notifications. These event notification map functions may be the end point for the notification, but they may also be the beginning point of initializing the event reporting and notification resources when an initialization signal travels in the reverse direction of the event notification to efficiently initialize these resources while leaving the logic surrounding them untouched.

Once the responding agent is notified of an event through a mapping, the agent may query that notifying map function to see how to access either a branch in the tree or neighbor in the ring topology. This continues until the query traverses to the specific event indicated by the map and reduction functions rather than the entire space of the possible event record resources. Once the relevant event record resources are identified, the agent processes the event record and the available information to formulate a response.

These capabilities may be combined to present a unified interface to the event notification and records. The summarization points may provide all the information needed to enable the responding agent to efficiently identify where relevant event records are stored. Thus, the summarization nodes in a tree or other topology may enable an agent to backtrace an event to find a record associated with the event and do not require the responding agent to know the topology, but dynamically indicates the topology and how to reach the most important event records based on the event notifications they provide. In some implementations, a design may be changed to remove an event, a recording resource, or change the intervening map and summary resource connectivity without affecting the responding agent's ability to traverse the event reporting and notification structure.

Some implementations may provide advantages over conventional systems for event recording and notification, such as, for example, providing scalable and configurable error reporting in a complex integrated circuit (e.g., an SOC), enabling an agent (e.g., a software agent) to process events without knowing the topology of the event recording and notification system, and enabling changes to the topology of an error reporting system without requiring updates to agents.

As used herein, the term “circuitry” refers to an arrangement of electronic components (e.g., transistors, resistors, capacitors, and/or inductors) that is structured to implement one or more functions. For example, a circuitry may include one or more transistors interconnected to form logic gates that collectively implement a logical function.

### Details

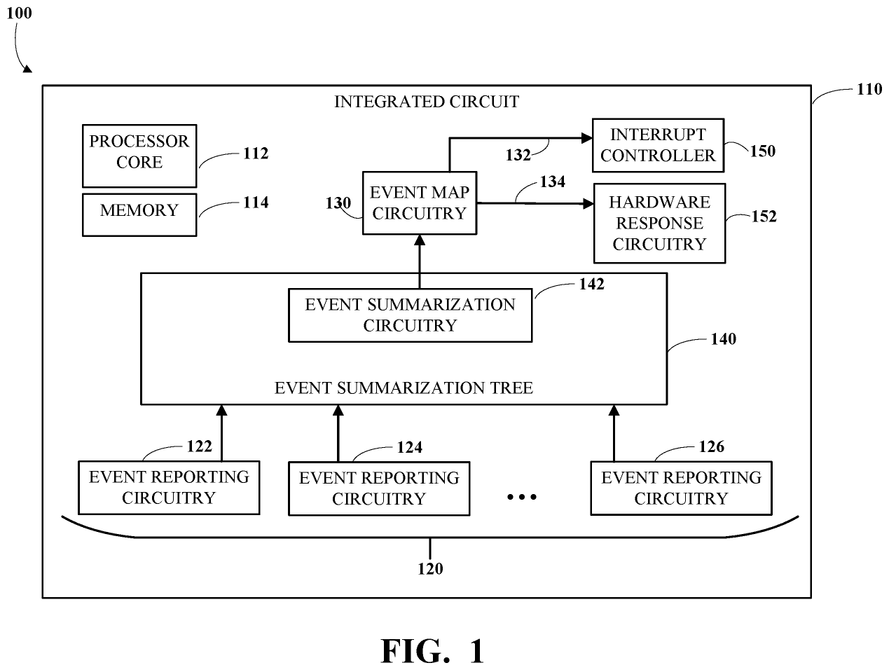

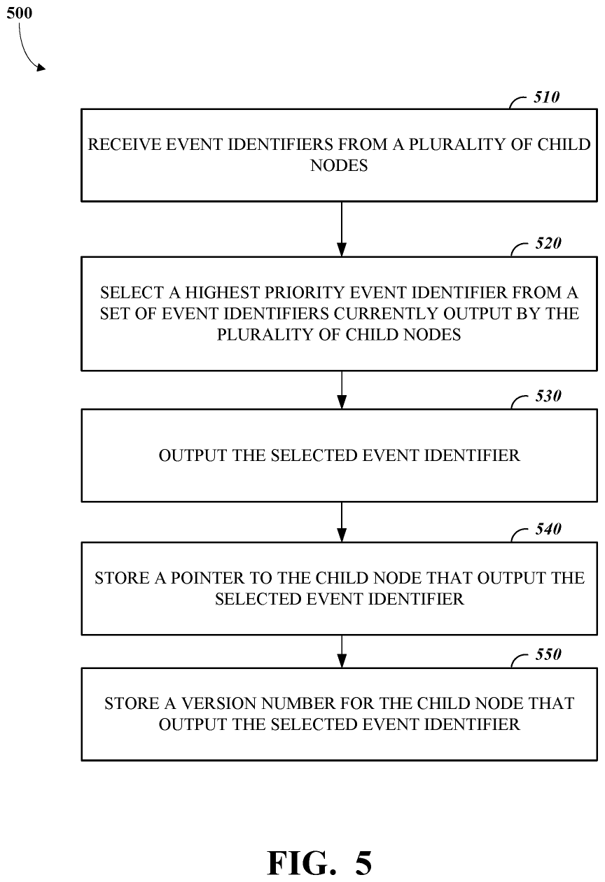

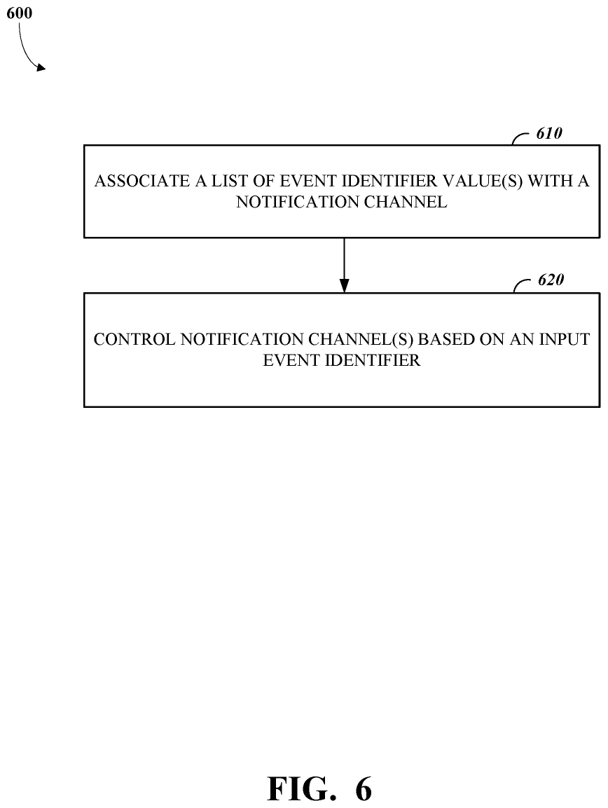

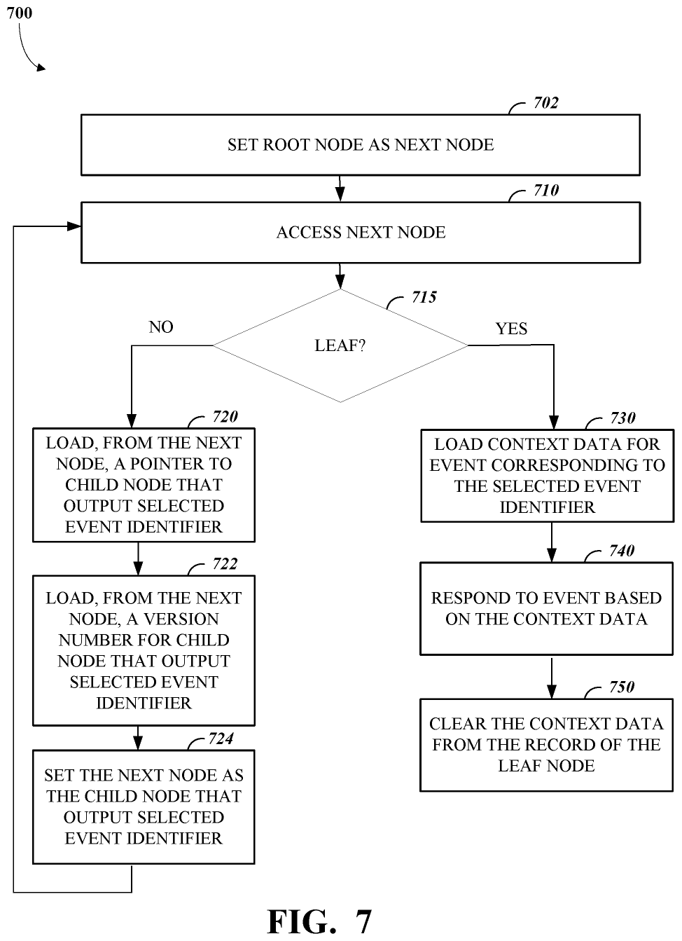

FIG. 1 is a block diagram of an example of a system 100 for enabling event recording and notification. The system 100 includes an integrated circuit 110 configured to enable event recording and notification. The integrated circuit 110 includes a processor core 112 and a memory 114. The integrated circuit 110 includes a plurality of event reporting circuitries 120 that are each configured to store context data for one or more detected events, including an event identifier for each of the one or more detected events. The integrated circuit 110 includes an event map circuitry 130 configured to control one or more notification channels based on an input event identifier. The integrated circuit 110 includes an event summarization tree 140 including an event summarization circuitry 142 that serves as a branching node in the event summarization tree 140. The event summarization circuitry 142 may be configured to take a plurality of event identifiers output by its child nodes as input and output a highest priority event identifier from this set of inputs. An event identifier output by the event summarization circuitry 142 may be passed to event map circuitry 130 to control notification channels. The integrated circuit 110 includes an interrupt controller 150 connected via a notification channel 132 to the event map circuitry 130. The interrupt controller 150 may be configured to issue interrupts to one or more agents that can process events, such as software agent running on the processor core 112 or another hardware circuitry that is interested in the events for response purposes. The integrated circuit 110 includes a hardware response circuitry 152, which may be configured to perform an operation in response to an event corresponding to an event identifier input to the event map circuitry 130 when a signal is received via the notification channel 134. Nodes in the event summarization tree 140, including the event summarization circuitry 142 may store data that can be used by an agent responding to an event notification to traverse the event summarization tree 140 to a leaf node that stores context data for the event that triggered the event notification. For example, the system 100 may be used to implement the process 500 of FIG. 5. For example, the system 100 may be used to implement the process 600 of FIG. 6. For example, the system 100 may be used to implement the process 700 of FIG. 7.

The system 100 includes an integrated circuit 110 (e.g., an SOC). In some implementations (not shown in FIG. 1), the system 100 may include multiple integrated circuits (e.g., chiplets) with nodes of the event summarization tree 140 distributed across the integrated circuits and passing event identifiers between nodes via communication channels (e.g., buses) connecting the integrated circuits.

The integrated circuit 110 includes a processor core 112 configured to execute instructions of an instruction set architecture. For example, the instruction set architecture may be a RISC-V instruction set architecture.

The integrated circuit 110 includes a memory system 114, which may include memory storing instructions and data and/or provide access to memory external to the integrated circuit 110 that stores instructions and/or data. For example, the memory system 114 may include random access memory. In some implementations, the memory system 114 includes one or more caches and an entry in the page table is accessed via the one or more caches. For example, the memory system 114 may include an L2 cache, which may be configured to implement a cache coherency protocol/policy to maintain cache coherency across multiple L1 caches. Although not shown in FIG. 1, the integrated circuit 110 may include multiple processor cores in some implementations. For example, the memory system 114 may include multiple layers.

The integrated circuit 110 includes a plurality of event reporting circuitries 120 that are each configured to store context data for one or more detected events, including an event identifier for each of the one or more detected events. For example, the one or more detected events may be errors detected by components of a system on a chip. For example, the event identifiers may be error identifiers. In this example, three event reporting circuitries (122, 124, and 126) are shown, but the system 100 may include any number of event reporting circuitries. The plurality of event reporting circuitries 120 may store information in a context-free way. For example, the event reporting circuitry 122 may include a bank with multiple entries to store information and a window that presents the most important one (e.g., a highest priority event identifier). For example, entries of the event reporting circuitry 122 may be considered as leaf nodes of a tree topology including the event summarization tree 140. The bank may also allow for personalization and a history of the last few error events that have occurred (e.g., by the event identifier). In some implementations, the event reporting circuitry 122 includes a configuration simple modifier that can override an event's assigned event identifier. A configuration modifier can be applied to override any portion of the events information, such as the event's identifier or other agent-relevant information. A complex modifier also specifies conditions for applying this override. In some implementations, the event reporting circuitry 122 includes a configuration complex modifier, which can override the event's assigned event identifier based on table or historic behavior and then trigger additional responses. In some implementations, the pool of modifiers is not 1:1 to an error event, but is assigned to an error event. The event reporting circuitry 122 may include an event summarization status register to provide software with a consistent way to see the status of recorded events. An event may present a valid and associated information to record in the event reporting circuitry 122. For example, the event reporting circuitry 122 may support local vs remote error event capability. Errors may be detected and recorded in close proximity to each other (i.e., local). They may also be separated in time or space from each other (i.e., remote). It may also be that in the remote case, the remote error detection is an IP with none or its own error record, but provides an error indication that is consumed and recorded as an error event on behalf of the “remote” case. Thus, an error can be recorded by event record logic (e.g., an error bank) without that error record logic being near in space, functionality, or time to the actual event detection/generation. In some implementations, at least one of the plurality of event reporting circuitries 120 (e.g., the event reporting circuitry 122) includes a race resolution circuitry (e.g., a semaphore) to control updates to context data for events that it stores. The race resolution circuitry may serve to prevent race conditions that could cause an event to be lost if it was detected while a write to an entry in an event reporting circuitry 122 is being performed. The race resolution circuitry may ensure that information is not lost for cases where a new event arrives while a register of the event reporting circuitry 122 is being cleared. In some implementations, the event reporting circuitry 122 may implement an event record facility and an event communication facility.

The integrated circuit 110 includes an event map circuitry 130 configured to control one or more notification channels based on an input event identifier (e.g., an error category). The input event identifier is decoded and a set of pins and/or interrupt assertions may be selected to assert when an event identifier value is seen. In some implementations (not explicitly shown in FIG. 1), other nodes (besides the root node of a tree topology) may have a local/mini-map circuitry to enable an error reporting circuitry 124 or another event summarization circuitry associated with a child node in the tree to directly signal critical event identifiers or to ensure they are associated with a specific context or circuitry. In some implementations, the event map circuitry 130 may also provide a parent to child reset. In this example, the one or more notification channels includes a conductor 132 connected between the event map circuitry 130 and an interrupt controller 150 (e.g., a platform level interrupt controller for the integrated circuit 110). In this example, the one or more notification channels includes an enable conductor 134 connected between the event map circuitry 130 and a hardware response circuitry 152 configured to perform an operation in response to an event corresponding to a selected event identifier that has been input to the event map circuitry 130. In some implementations, the event map circuitry 130 is configurable by software to associate a list of one or more event identifier values with one of the one or more notification channels. There may be one or more event signaling controllers in a design. One reason for multiple is to generate localized interrupts (e.g., Hart X has an event and Hart X is interrupted) or global interrupts (e.g., Hart X or Hart Y or IP A have an event and Hart Z is interrupted).

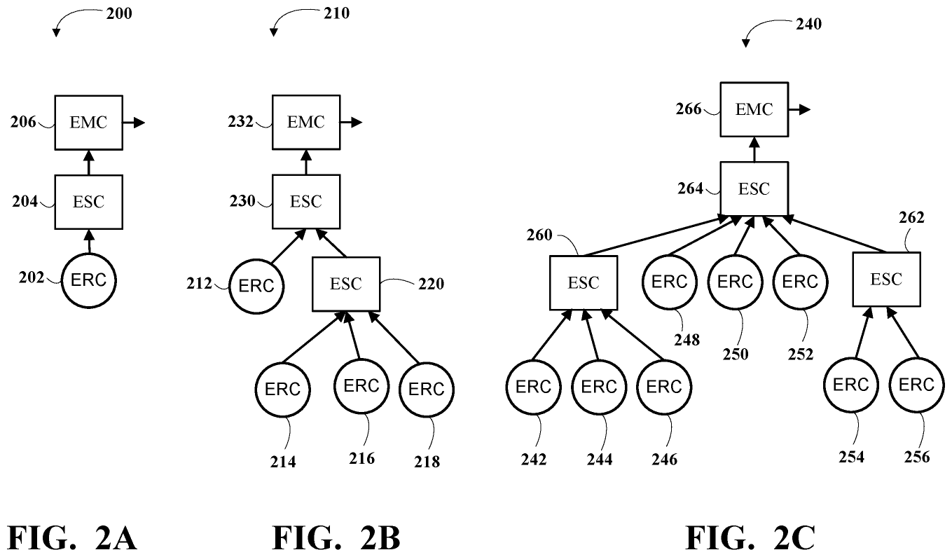

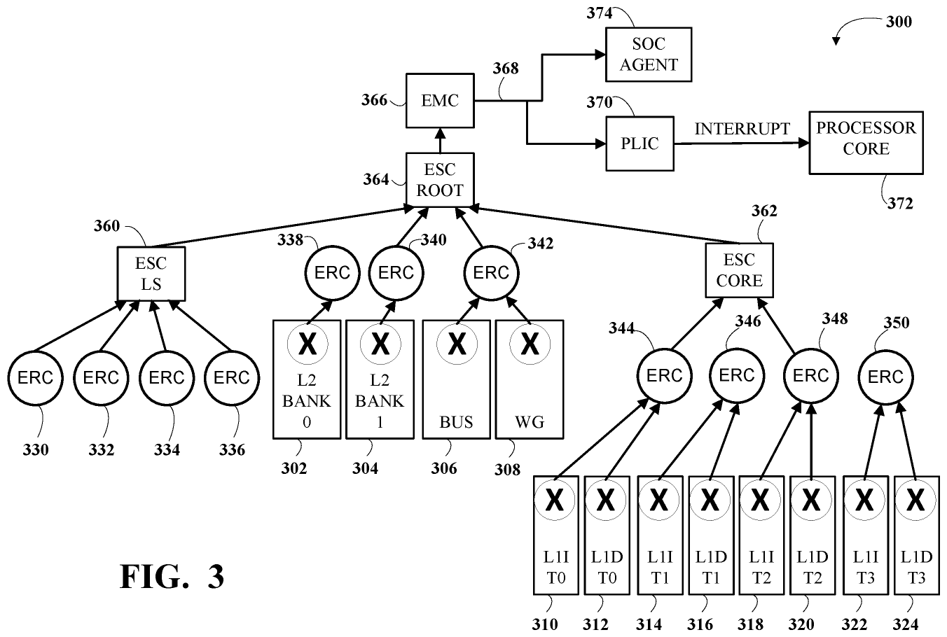

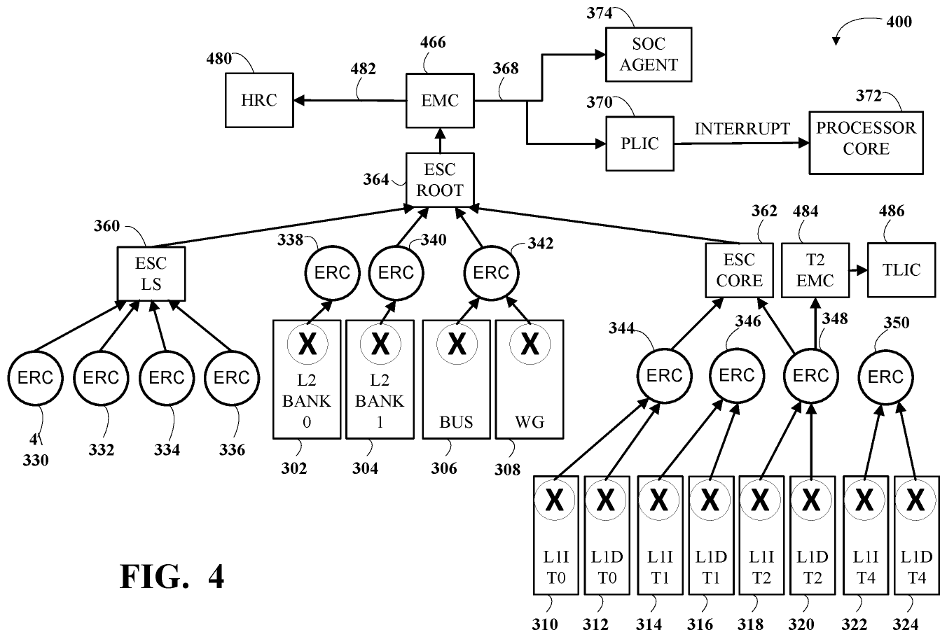

The integrated circuit 110 includes an event summarization circuitry 142. The event summarization circuitry 142 is a node in an event summarization tree 140 that connects the plurality of event reporting circuitries 120 to the event map circuitry 130. At any given time, a highest priority event identifier propagates up through the tree to the event map circuitry 130 to cause one or more agents of the system 100 to be notified of the associated high priority event. The nodes in the event summarization tree 140 store data to enable an agent responding to an event notification to traverse the event summarization tree 140 to a leaf node that stores context data for the event that triggered the event notification. The one or more nodes of the event summarization tree 140 may be distributed around the integrated circuit 110 to aggregate event notifications from different respective regions of the integrated circuit 110. In this example, the event summarization circuitry 142 is the root node of the event summarization tree 140. The event summarization tree 140 may include additional event summarization circuitries as additional nodes in the tree. For example, the event summarization tree 140 may be configured to implement the tree topology 200 of FIG. 2A. For example, the event summarization tree 140 may be configured to implement the tree topology 210 of FIG. 2B. For example, the event summarization tree 140 may be configured to implement the tree topology 240 of FIG. 2C. For example, the event summarization tree 140 may be configured to implement the tree topology 300 of FIG. 3. For example, the event summarization tree 140 may be configured to implement the tree topology 400 of FIG. 4.

The event summarization circuitry 142 may be configured to receive event identifiers from the plurality of child nodes, wherein each child node is one of the plurality of event reporting circuitries 120 or another event summarization circuitry (e.g., another node in the event summarization tree 140) configured to output an event identifier from one of the plurality of event reporting circuitries 120; select a highest priority event identifier from a set of event identifiers currently output by the plurality of child nodes; output the selected event identifier to the event map circuitry 130; and store (e.g., in a memory-mapped register) a pointer to the child node that output the selected event identifier. The event summarization circuitry 142 may collect event identifiers from other event summarization circuitries (i.e., other nodes in the event summarization tree 140) or event reporting circuitries 120 (e.g., mix and match). The event summarization circuitry 142 identifies the most important of those inputs and that becomes its output. The event summarization circuitry 142 may also provide a snapshot of all of its inputs and where the most important inputs may be found and how to access this information (e.g., what type of resource stores the information and what version of that resource it is). Thus, the event summarization circuitry 142 may have status and pointers to how to access the information it summarizes. For example, the pointer may be an access token. In some implementations the pointer may include an address (e.g., a memory-mapped address) and/or a leaf/branch identifier. In some implementations, the event summarization circuitry 142 may be configured to receive an action identifier associated with the selected event identifier from one of the plurality of child nodes, and output the action identifier to the event map circuitry. The action identifier associated with the selected event identifier may provide additional information about an event to enable an agent receiving a notification including the selected event identifier and its associated action identifier to perform an action in response to the event before traversing the event summarization tree 140 to retrieve the rest of the context data for the event associated with the selected event identifier. In some implementations additional context data for an event may be passed up through the event summarization tree 140 and distributed via the event map circuitry 130 to an agent to enable faster response to the event.

In some implementations, the event summarization circuitry is configured to store (e.g., in a memory-mapped register) child identification data for the child node that output the selected event identifier. For example, the child identification data may include a version number and/or a child type indicator (e.g., branching summary node vs. leaf storage node). This version number may be used by an agent traversing the tree to more efficiently interact with different versions of hardware that could be used to implement the child node. In some implementations, the event summarization circuitry 142 includes a history circuitry configured to store a temporally ordered list of event identifiers received from the plurality of child nodes. The history circuitry may be configured to associate each entry of the temporally ordered list with one of the plurality of child nodes. For example, the history circuitry may be implemented with a buffer storing information for the last N events that were passed up through the event summarization circuitry 142. For example, the history circuitry may include counters for various types of events that were passed up through the event summarization circuitry 142. The history circuitry (e.g., history stack circuitry) may be used to investigate longer term patterns in events (e.g., errors) reported through the system 100. Events whose context data has been cleared (e.g., by an agent that processed the event) from the leaf nodes of the tree topology may still be reflected in the history circuitry.

When traversing the event summarization tree 140 to recover context data for an event, an agent may access a chain of nodes, starting with the root node. For example, the agent traversing the tree may be software running on the processor core 112 in response to an interrupt from the interrupt controller 150. For example, agent may load the pointer to the child node that output the selected event identifier that is stored by the event summarization circuitry 142; and access, using the pointer, the child node that output the selected event identifier. The event summarization circuitry 142 may be part of a tree including multiple levels of summarization nodes and the memory 114 may store instructions that, when executed by the processor core 112, cause the processor core to iteratively access successive child nodes until one of the plurality of event reporting circuitries 120 is accessed to load context data for an event corresponding to the selected event identifier. Thus, the summarization nodes in the event summarization tree 140 may enable an agent to backtrace an event to find a record associated with the event without requiring the responding agent to know the topology. An agent may dynamically determine how to reach the most important event records based on the event notifications they provide. In some implementations, a design may be changed to remove an event, a recording resource, or change the intervening map and summary resource connectivity without affecting the responding agent's ability to traverse the event reporting and notification structure. In some implementations, the integrated circuit 110 may include multiple event summarization trees, each tree having its own root node. Different event summarization trees may output signals to different agents in or associated with the integrated circuit 110. For example, one event summarization tree may output signals to software running on the processor core 112, another event summarization tree may output signals to a hardware implemented agent (e.g., the hardware response circuitry 152), and/or another event summarization tree may output signals via pins of the integrated circuit to an agent running on a device outside of the integrated circuit (e.g., a host connected via a serial port). In some implementations, multiple event summarization trees may share common event reporting circuitries and/or common event summarization circuitries at lower levels in a tree.

Generally, these circuitries that perform different roles in an event summarization and reporting system may also be combined into a single instance (e.g., an event reporting circuitry with an event map circuitry, a small group of event reporting circuitries, or an event summarization circuitry with an event map circuitry). The circuitries may be combined in a single circuitry if warranted.

FIGS. 2A-2C are block diagrams of examples of tree topologies for enabling event recording and notification.

FIG. 2A is a block diagram of an example of a tree topology 200 for enabling event (e.g., error) recording and notification. The tree topology 200 includes a single event reporting circuitry 202 (e.g., including an error bank) that outputs one or more event identifiers to an event summarization circuitry 204. The event summarization circuitry 204 (e.g., including an error summary register) selects a highest priority event from among the one or more event identifiers currently being received from the event reporting circuitry 202. The event summarization circuitry 204 outputs the selected event identifier to an event mapping circuitry 206 (e.g., including an error signal register), which is configured to control one or more notification channels based on an input event identifier. For example, the event reporting circuitry 202 may implement an event record facility and an event communication facility. For example, the event summarization circuitry 204 may implement an event notification summarization facility. For example, the event mapping circuitry 206 may implement an event notification map facility.

FIG. 2B is a block diagram of an example of a tree topology 210 for enabling event (e.g., error) recording and notification. The tree topology 210 is similar to the tree topology 200, but the tree topology 210 includes two layers of summarization. The tree topology 210 includes a first event reporting circuitry 212, a second event reporting circuitry 214, a third event reporting circuitry 216, and a fourth event reporting circuitry 218. The second event reporting circuitry 214, a third event reporting circuitry 216, and a fourth event reporting circuitry 218 are configured to output event identifiers to an event summarization circuitry 220. The tree topology 210 includes an event summarization circuitry 230, which serves as a root node of the tree topology 210. The event summarization circuitry 230 takes event identifiers from the first event reporting circuitry 212 and from the event summarization circuitry 220 as inputs, and outputs a highest priority event identifier to an event mapping circuitry 232, which is configured to control one or more notification channels based on an input event identifier from the event summarization circuitry 230.

FIG. 2C is a block diagram of an example of a tree topology 240 for enabling event (e.g., error) recording and notification. The tree topology 240 is similar to the tree topology 200 and the tree topology 210, but the tree topology 210 includes even more nodes. The tree topology 240 includes a first event reporting circuitry 242, a second event reporting circuitry 244, a third event reporting circuitry 246, a fourth event reporting circuitry 248, a fifth event reporting circuitry 250, a sixth event reporting circuitry 252, a seventh event reporting circuitry 254, and an eighth event reporting circuitry 256. The first event reporting circuitry 242, the second event reporting circuitry 244, and the third event reporting circuitry 246 are configured to output event identifiers to an event summarization circuitry 260. The seventh event reporting circuitry 254 and the eighth event reporting circuitry 256 are configured to output event identifiers to an event summarization circuitry 262. The tree topology 240 includes an event summarization circuitry 264, which serves as a root node of the tree topology 240. The event summarization circuitry 264 takes event identifiers from the fourth event reporting circuitry 248, the fifth event reporting circuitry 250, the sixth event reporting circuitry 252, the event summarization circuitry 260, and from the event summarization circuitry 262 as inputs, and outputs a highest priority event identifier to an event mapping circuitry 266, which is configured to control one or more notification channels based on an input event identifier from the event summarization circuitry 264.

FIG. 3 is a block diagram of an example of a tree topology 300 for event recording and notification. The tree topology 300 takes input event data from a variety of event sources (e.g., error detectors) located in various components of a system being monitored (e.g., an SOC). The tree topology 300 takes input event data from an error detector in a first bank of an L2 cache 302, an error detector in a second bank of an L2 cache 304, an error detector in a bus 306 (e.g., in a Tilelink bus), an hardware enforced access control system 308 (e.g., in a WorldGuard checker), an error detector in an L1 instruction cache 310 in a first processor core or tile, an error detector in an L1 data cache 312 in the first processor core or tile, an error detector in an L1 instruction cache 314 in a second processor core or tile, an error detector in an L1 data cache 316 in the second processor core or tile, an error detector in an L1 instruction cache 318 in a third processor core or tile, an error detector in an L1 data cache 320 in the third processor core or tile, an error detector in an L1 instruction cache 322 in a fourth processor core or tile, and an error detector in an L1 data cache 324 in the fourth processor core or tile. The tree topology 300 includes a first event reporting circuitry 330, a second event reporting circuitry 332, a third event reporting circuitry 334, a fourth event reporting circuitry 336, a fifth event reporting circuitry 338, a sixth event reporting circuitry 340, a seventh event reporting circuitry 342, an eighth event reporting circuitry 344, a ninth event reporting circuitry 346, a tenth event reporting circuitry 348, and an eleventh event reporting circuitry 350. The fifth event reporting circuitry 338 is configured to record event data received from the error detector in the first bank of the L2 cache 302. The sixth event reporting circuitry 340 is configured to record event data received from the error detector in the second bank of the L2 cache 304. The seventh event reporting circuitry 342 is configured to record event data received from the error detector in the bus 306 and from the hardware enforced access control system 308. The eighth event reporting circuitry 344 is configured to record event data received from the error detector in an L1 instruction cache 310 in the first processor core or tile and from the error detector in the L1 data cache 312 in the first processor core or tile. The ninth event reporting circuitry 346 is configured to record event data received from the error detector in the L1 instruction cache 314 in the second processor core or tile and from the error detector in the L1 data cache 316 in the second processor core or tile. The tenth event reporting circuitry 348 is configured to record event data received from the error detector in the L1 instruction cache 318 in the third processor core or tile and from the error detector in the L1 data cache 320 in the third processor core or tile. The eleventh event reporting circuitry 350 is configured to record event data received from the error detector in the L1 instruction cache 322 in the fourth processor core or tile and from the error detector in the L1 data cache 324 in the fourth processor core or tile. The first event reporting circuitry 330, the second event reporting circuitry 332, the third event reporting circuitry 334, and the fourth event reporting circuitry 336 may be configured to record event data received from a variety of system components, such as components of a lockstep suite of processor cores (not shown in FIG. 3 for lack of space).

The first event reporting circuitry 330, the second event reporting circuitry 332, the third event reporting circuitry 334, and the fourth event reporting circuitry 336 are configured to output event identifiers to an event summarization circuitry 360 associated with the lockstep suite of processor cores. The eighth event reporting circuitry 344 and the tenth event reporting circuitry 348 are configured to output event identifiers to an event summarization circuitry 362 associated with a cluster of processor cores. The tree topology 300 includes an event summarization circuitry 364, which serves as a root node of the tree topology 300. The event summarization circuitry 364 takes event identifiers from the sixth event reporting circuitry 340 and the seventh event reporting circuitry 342, the event summarization circuitry 360, and from the event summarization circuitry 362 as inputs, and outputs a highest priority event identifier to an event mapping circuitry 366, which is configured to control one or more notification channels 368 based on an input event identifier from the event summarization circuitry 364. One of the one or more notification channels 368 connects the event mapping circuitry 366 to a platform level interrupt controller 370. Signals driven on this notification channel may cause the platform level interrupt controller 370 to generate interrupts that may be consumed by a processor core 372, which may run agent software (e.g., including an interrupt handling routine). One of the one or more notification channels 368 connects the event mapping circuitry 366 to an SOC level hardware agent 374, which may be configured to implement a response (e.g., a reset and/or an error logging function) to an event (e.g., an error).

FIG. 4 is a block diagram of an example of a tree topology 400 for event recording and notification with a localized event mapping circuitry taps the tree topology 400 at a lower level to facilitate a potentially faster localized response. The tree topology 400 is the same as the tree topology 300 of FIG. 3, with some added components around the tree to enhance event response in some situations. The tree topology 400 includes a local event mapping circuitry 484 that takes event identifiers from the tenth event reporting circuitry 348 related to the third processor core or tile in the core cluster as input. The local event mapping circuitry 484 is configured to control one or more notification channels based on an input event identifier from the tenth event reporting circuitry 348. One of the one or more notification channels connects the local event mapping circuitry 484 to a tile level interrupt controller 486. Signals driven on this notification channel may cause the tile level interrupt controller 486 to generate interrupts that may be consumed by a third processor core or tile that was the source of the underlying event. The local event mapping circuitry 484 may enable faster local responses to events (e.g., a faster pipeline flush or localized reset). In some implementations (not shown in FIG. 4), event identifiers from the event recording circuitry are routed to the event summarization circuitry 362 through the local event mapping circuitry 484, rather than passing directly to the event summarization circuitry 362, and the local event mapping circuitry 484 is configured to optionally mask/not forward event identifiers, thus performing an event notification filtering function. For example, the local event mapping circuitry 484 may provide configuration for which notifications to intercept and map to notifications or to pass on without action. The root level event mapping circuitry 466 is modified slightly to control a notification channel 482 including a conductor connecting the event mapping circuitry 466 to a hardware response circuitry 480 (e.g., the hardware response circuitry 152), which may be configured to implement a quick response to an underlying event.

FIG. 5 is a flow chart of an example of a process 500 for event recording and notification. The process 500 includes receiving 510 event identifiers from a plurality of child nodes, wherein each child node is one of a plurality of event reporting circuitries or an event summarization circuitry configured to output an event identifier from one of the plurality of event reporting circuitries; selecting 520 a highest priority event identifier from a set of event identifiers currently output by the plurality of child nodes; outputting 530 the selected event identifier to an event map circuitry; storing 540 a pointer to the child node that output the selected event identifier; and storing 550 a version number for the child node that output the selected event identifier. For example, the process 500 may be implemented using the system 100 of FIG. 1.

The process 500 includes receiving 510 event identifiers from a plurality of child nodes. Each child node is one of a plurality of event reporting circuitries (e.g., the plurality of event reporting circuitries 120) or an event summarization circuitry configured to output an event identifier from one of the plurality of event reporting circuitries.

The process 500 includes selecting 520 a highest priority event identifier from a set of event identifiers currently output by the plurality of child nodes. For example, the event identifiers may be unsigned integers that are prioritized based on their magnitudes. In some implementations, software may be able to configure an event summarization circuitry implementing the process 500 to prioritize a set of possible event identifier values in an arbitrary order. For example, the selected event identifier may be an indication of an error detected by a component of a system on a chip with context data for the error stored in one of the plurality of event reporting circuitries.

The process 500 includes outputting 530 the selected event identifier to an event map circuitry (e.g., the event map circuitry 130). For example, the selected event identifier may be written to an error summary output register and/or transmitted on a bus in order to output 530 the selected event identifier. For example, the event map circuitry may be configured to control one or more notification channels based on an input event identifier, and the one or more notification channels may include a conductor connected between the event map circuitry and an interrupt controller. For example, the event map circuitry may be configured to control one or more notification channels based on an input event identifier, and the one or more notification channels may include an enable conductor connected between the event map circuitry and a hardware response circuitry configured to perform an operation in response to an event corresponding to the selected event identifier. In some implementations, the mapping from an event identifier to one or more notification channels may be configurable by software. For example, the process 500 may be augmented to further include associating a list of one or more event identifier values with a notification channel. For example, the process 500 may include implementing the process 600 of FIG. 6.

The process 500 includes storing 540 a pointer to the child node that output the selected event identifier. For example, the pointer may be stored 550 in a memory-mapped register of a node implementing the process 500. Storing 540 the pointer may enable an agent responding to a resulting event notification to traverse a tree topology, including the node implementing the process 500, to access context data for an event stored at a leaf of the tree topology. For example, the child node may include memory-mapped registers and the pointer may include a base address associated with the child node. For example, the pointer may be an access token. In some implementations, the pointer may include an address (e.g., a memory-mapped address) and/or a leaf/branch identifier. In an example, the pointer stored 540 may be an index identifying a record associated with the selected child, where a record associated with a child encodes information sufficient to access the child, such as a memory-mapped address of the child. For example, this address stored in a record associated with the child may be determined at elaboration time.

The process 500 includes storing 550 a version number for the child node that output the selected event identifier. For example, the version number may be stored 550 in a memory-mapped register of a node implementing the process 500. This version number may be used by an agent traversing the tree to more efficiently interact with different versions of hardware that could be used to implement the child node. In some implementations, version number may be stored 550 indirectly by storing 550 an index identifying a record associated with the selected child, where a record associated with a child encodes a version number for the child node. For example, this version number encoded in a record associated with the child may be determined at elaboration time.

An agent responding to an event notification resulting from the selected event identifier may traverse the tree including node implementing the process 500 in order to access context data for an event (e.g., an error) corresponding to the selected event identifier. Thus, the process 500 may be augmented to further include loading the pointer to the child node that output the selected event identifier that is stored by the event summarization circuitry; and accessing, using the pointer, the child node that output the selected event identifier. The process 500 may be augmented to include iteratively accessing successive child nodes until one of the plurality of event reporting circuitries is accessed to load context data for an event corresponding to the selected event identifier. For example, the process 500 may include implementing the process 700 of FIG. 7.

In some cases, it may be useful to track longer term trends in the events (e.g., errors) being reported through the system implementing the process 500. For example, the process 500 may further include storing a temporally ordered list of event identifiers received from the plurality of child nodes in a history circuitry (e.g., including a queue of records storing received event identifiers). In some implementations, the history circuitry is configured to associate each entry of the temporally ordered list with one of the plurality of child nodes. In some implementations, the history circuitry includes counters for various values of event identifier that are incremented when an event identifier with that value is received by a node or when an event identifier with that value is output by the node.

FIG. 6 is a flow chart of an example of a process 600 for controlling one or more notification channels based on an input event identifier. The process 600 includes associating 610 a list of one or more event identifier values with a notification channel. For example, the list of one or more event identifier values may be associated 610 with the notification channel by software that sets flags in memory mapped register of the event map circuitry that is associated with the notification channel, where each bit of the register corresponds to a reserved value or range of values for the event identifiers. The process 600 includes controlling 620 one or more notification channels based on an input event identifier. In some implementations, the event map circuitry is configured to control one or more notification channels based on an input event identifier, and the one or more notification channels include a conductor connected between the event map circuitry and an interrupt controller. In some implementations, the event map circuitry is configured to control one or more notification channels based on an input event identifier, and the one or more notification channels include an enable conductor connected between the event map circuitry and a hardware response circuitry configured to perform an operation in response to an event corresponding to the selected event identifier. For example, the process 600 may be implemented using the system 100 of FIG. 1.

FIG. 7 is a flow chart of an example of a process 700 for traversing a tree topology to access context data for an event corresponding to an event identifier output by the tree. The process 700 includes setting 702 the next node to be a root node of a tree topology that output the event identifier associated with an event to be processed; and accessing 710 the next node in the tree topology. If, at step 715, the next node is not a leaf node, then the process 700 includes loading 720, from the next node, the pointer to the child node that output the selected event identifier; loading 722, from the next node, a version number for the child node that output the selected event identifier; and setting 724 the next node to be the child node that output the selected event identifier. The pointer is used to set 724 the child node as the next node and the process continues by accessing 710 the child node using the pointer and/or the version number. If, at step 715, the next node is a leaf node, then the process 700 includes loading 730, from the next node, context data for an event corresponding to the selected event identifier; responding 740 to the event based on the context data; and clearing 750 the context data from the record of the leaf node. The process 700 may be used to iteratively access successive child nodes until one of the leaf nodes is accessed to load context data for an event corresponding to a selected event identifier associated with an event notification signal and an underlying event to be processed. For example, the process 700 may be implemented using the system 100 of FIG. 1.

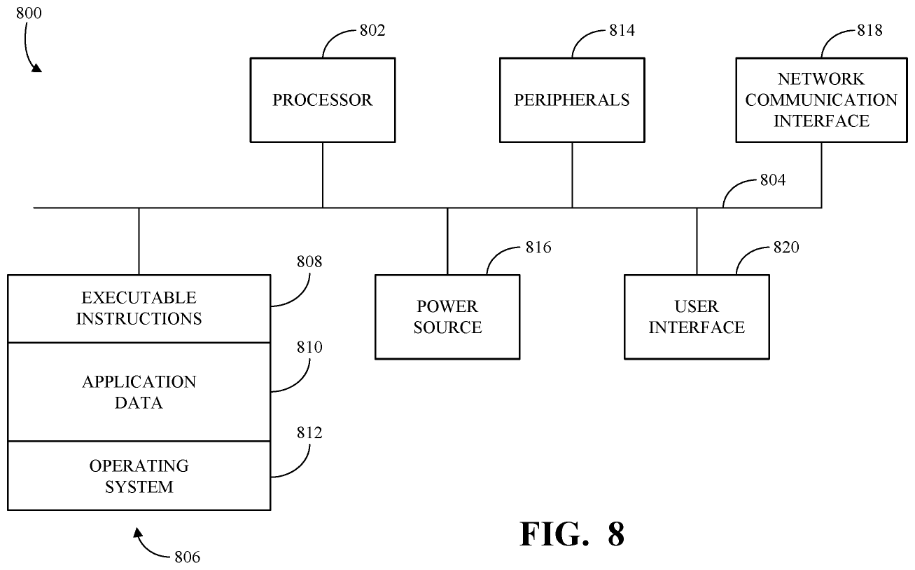

FIG. 8 is a block diagram of an example of a system 800 for facilitating generation of a circuit representation. The system 800 is an example of an internal configuration of a computing device. For example, the system 800 may be used to generate a file that generates a circuit representation of an integrated circuit (e.g., the integrated circuit 110), including a processor core (e.g., the processor core 112), and an event summarization tree (e.g., the event summarization tree 140). The system 800 can include components or units, such as a processor 802, a bus 804, a memory 806, peripherals 814, a power source 816, a network communication interface 818, a user interface 820, other suitable components, or a combination thereof.

The processor 802 can be a central processing unit (CPU), such as a microprocessor, and can include single or multiple processors having single or multiple processing cores. Alternatively, the processor 802 can include another type of device, or multiple devices, now existing or hereafter developed, capable of manipulating or processing information. For example, the processor 802 can include multiple processors interconnected in any manner, including hardwired or networked, including wirelessly networked. In some implementations, the operations of the processor 802 can be distributed across multiple physical devices or units that can be coupled directly or across a local area or other suitable type of network. In some implementations, the processor 802 can include a cache, or cache memory, for local storage of operating data or instructions.

The memory 806 can include volatile memory, non-volatile memory, or a combination thereof. For example, the memory 806 can include volatile memory, such as one or more dynamic random-access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 806 can include another type of device, or multiple devices, now existing or hereafter developed, capable of storing data or instructions for processing by the processor 802. The processor 802 can access or manipulate data in the memory 806 via the bus 804. Although shown as a single block in FIG. 8, the memory 806 can be implemented as multiple units. For example, a system 800 can include volatile memory, such as random-access memory (RAM), and persistent memory, such as a hard drive or other storage.

The memory 806 can include executable instructions 808, data, such as application data 810, an operating system 812, or a combination thereof, for immediate access by the processor 802. The executable instructions 808 can include, for example, one or more application programs, which can be loaded or copied, in whole or in part, from non-volatile memory to volatile memory to be executed by the processor 802. The executable instructions 808 can be organized into programmable modules or algorithms, functional programs, codes, code segments, or combinations thereof to perform various functions described herein. For example, the executable instructions 808 can include instructions executable by the processor 802 to cause the system 800 to automatically, in response to a command, generate an integrated circuit design and associated test results based on a design parameters data structure. The application data 810 can include, for example, user files, database catalogs or dictionaries, configuration information or functional programs, such as a web browser, a web server, a database server, or a combination thereof. The operating system 812 can be, for example, Microsoft Windows®, macOS®, or Linux®; an operating system for a small device, such as a smartphone or tablet device; or an operating system for a large device, such as a mainframe computer. The memory 806 can comprise one or more devices and can utilize one or more types of storage, such as solid-state or magnetic storage.

The peripherals 814 can be coupled to the processor 802 via the bus 804. The peripherals 814 can be sensors or detectors, or devices containing any number of sensors or detectors, which can monitor the system 800 itself or the environment around the system 800. For example, a system 800 can contain a temperature sensor for measuring temperatures of components of the system 800, such as the processor 802. Other sensors or detectors can be used with the system 800, as can be contemplated. In some implementations, the power source 816 can be a battery, and the system 800 can operate independently of an external power distribution system. Any of the components of the system 800, such as the peripherals 814 or the power source 816, can communicate with the processor 802 via the bus 804.

The network communication interface 818 can also be coupled to the processor 802 via the bus 804. In some implementations, the network communication interface 818 can comprise one or more transceivers. The network communication interface 818 can, for example, provide a connection or link to a network, via a network interface, which can be a wired network interface, such as Ethernet, or a wireless network interface. For example, the system 800 can communicate with other devices via the network communication interface 818 and the network interface using one or more network protocols, such as Ethernet, transmission control protocol (TCP), Internet protocol (IP), power line communication (PLC), Wi-Fi, infrared, general packet radio service (GPRS), global system for mobile communications (GSM), code division multiple access (CDMA), or other suitable protocols.

A user interface 820 can include a display; a positional input device, such as a mouse, touchpad, touchscreen, or the like; a keyboard; or other suitable human or machine interface devices. The user interface 820 can be coupled to the processor 802 via the bus 804. Other interface devices that permit a user to program or otherwise use the system 800 can be provided in addition to or as an alternative to a display. In some implementations, the user interface 820 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 814. The operations of the processor 802 can be distributed across multiple clients or servers, which can be coupled directly or across a local area or other suitable type of network. The memory 806 can be distributed across multiple clients or servers, such as network-based memory or memory in multiple clients or servers performing the operations of clients or servers. Although depicted here as a single bus, the bus 804 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming. In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

In a first aspect, the subject matter described in this specification can be embodied in an apparatus that includes a plurality of event reporting circuitries that are each configured to store context data for one or more detected events, including an event identifier for each of the one or more detected events; an event map circuitry configured to control one or more notification channels based on an input event identifier; and an event summarization circuitry configured to: receive event identifiers from a plurality of child nodes, wherein each child node is one of the plurality of event reporting circuitries or another event summarization circuitry configured to output an event identifier from one of the plurality of event reporting circuitries; select a highest priority event identifier from a set of event identifiers currently output by the plurality of child nodes; output the selected event identifier to the event map circuitry; and store a pointer to the child node that output the selected event identifier.

In the first aspect, the apparatus may include a processor core configured to execute instructions; and a memory storing instructions that, when executed by the processor core, cause the processor core to: load the pointer to the child node that output the selected event identifier that is stored by the event summarization circuitry; and access, using the pointer, the child node that output the selected event identifier. In the first aspect, the event summarization circuitry may be part of a tree including multiple levels of summarization nodes and the memory may store instructions that, when executed by the processor core, cause the processor core to: iteratively access successive child nodes until one of the plurality of event reporting circuitries is accessed to load context data for an event corresponding to the selected event identifier. In the first aspect, the one or more notification channels may include a conductor connected between the event map circuitry and an interrupt controller. In the first aspect, the one or more notification channels may include an enable conductor connected between the event map circuitry and a hardware response circuitry configured to perform an operation in response to an event corresponding to the selected event identifier. In the first aspect, the event map circuitry may be configurable by software to associate a list of one or more event identifier values with one of the one or more notification channels. In the first aspect, the event summarization circuitry may include a history circuitry configured to store a temporally ordered list of event identifiers received from the plurality of child nodes. For example, the history circuitry may be configured to associate each entry of the temporally ordered list with one of the plurality of child nodes. In the first aspect, the event summarization circuitry may be configured to: store a version number for the child node that output the selected event identifier. In the first aspect, at least one of the plurality of event reporting circuitries may include a race resolution circuitry to control updates to context data for events that it stores. In the first aspect, the one or more detected events may be errors detected by components of a system on a chip. In the first aspect, the event summarization circuitry may be configured to: receive an action identifier associated with the selected event identifier from one of the plurality of child nodes; and output the action identifier to the event map circuitry.

In a second aspect, the subject matter described in this specification can be embodied in methods that include receiving event identifiers from a plurality of child nodes, wherein each child node is one of a plurality of event reporting circuitries or an event summarization circuitry configured to output an event identifier from one of the plurality of event reporting circuitries; selecting a highest priority event identifier from a set of event identifiers currently output by the plurality of child nodes; outputting the selected event identifier to an event map circuitry; and storing a pointer to the child node that output the selected event identifier.

In the second aspect, the methods may include loading the pointer to the child node that output the selected event identifier; and accessing, using the pointer, the child node that output the selected event identifier. In the second aspect, the methods may include iteratively accessing successive child nodes until one of the plurality of event reporting circuitries is accessed to load context data for an event corresponding to the selected event identifier. In the second aspect, the event map circuitry may be configured to control one or more notification channels based on an input event identifier, and the one or more notification channels may include a conductor connected between the event map circuitry and an interrupt controller. In the second aspect, the event map circuitry may be configured to control one or more notification channels based on an input event identifier, and the one or more notification channels may include an enable conductor connected between the event map circuitry and a hardware response circuitry configured to perform an operation in response to an event corresponding to the selected event identifier. In the second aspect, the methods may include associating a list of one or more event identifier values with a notification channel. In the second aspect, the methods may include storing a temporally ordered list of event identifiers received from the plurality of child nodes in a history circuitry. For example, the history circuitry may be configured to associate each entry of the temporally ordered list with one of the plurality of child nodes. In the second aspect, the methods may include storing a version number for the child node that output the selected event identifier. In the second aspect, at least one of the plurality of event reporting circuitries may include a race resolution circuitry to control updates to context data for events that it stores. In the second aspect, the selected event identifier may be an indication of an error detected by a component of a system on a chip. In the second aspect, the methods may include receiving an action identifier associated with the selected event identifier from one of the plurality of child nodes; and outputting the action identifier to the event map circuitry.

In a third aspect, the subject matter described in this specification can be embodied in a non-transitory computer readable medium comprising a circuit representation that, when processed by a computer, is used to program or manufacture an integrated circuit that includes a plurality of event reporting circuitries that are each configured to store context data for one or more detected events, including an event identifier for each of the one or more detected events; an event map circuitry configured to control one or more notification channels based on an input event identifier; and an event summarization circuitry configured to: receive event identifiers from a plurality of child nodes, wherein each child node is one of the plurality of event reporting circuitries or another event summarization circuitry configured to output an event identifier from one of the plurality of event reporting circuitries; select a highest priority event identifier from a set of event identifiers currently output by the plurality of child nodes; output the selected event identifier to the event map circuitry; and store a pointer to the child node that output the selected event identifier.

In the third aspect, the integrated circuit may include a processor core configured to execute instructions; and a memory storing instructions that, when executed by the processor core, cause the processor core to: load the pointer to the child node that output the selected event identifier that is stored by the event summarization circuitry; and access, using the pointer, the child node that output the selected event identifier. In the third aspect, the event summarization circuitry may be part of a tree including multiple levels of summarization nodes and the memory may store instructions that, when executed by the processor core, cause the processor core to: iteratively access successive child nodes until one of the plurality of event reporting circuitries is accessed to load context data for an event corresponding to the selected event identifier. In the third aspect, the one or more notification channels may include a conductor connected between the event map circuitry and an interrupt controller. In the third aspect, the one or more notification channels may include an enable conductor connected between the event map circuitry and a hardware response circuitry configured to perform an operation in response to an event corresponding to the selected event identifier. In the third aspect, the event map circuitry may be configurable by software to associate a list of one or more event identifier values with one of the one or more notification channels. In the third aspect, the event summarization circuitry may include a history circuitry configured to store a temporally ordered list of event identifiers received from the plurality of child nodes. For example, the history circuitry may be configured to associate each entry of the temporally ordered list with one of the plurality of child nodes. In the third aspect, the event summarization circuitry may be configured to: store a version number for the child node that output the selected event identifier. In the third aspect, at least one of the plurality of event reporting circuitries may include a race resolution circuitry to control updates to context data for events that it stores. In the third aspect, the one or more detected events may be errors detected by components of a system on a chip. In the third aspect, the event summarization circuitry may be configured to: receive an action identifier associated with the selected event identifier from one of the plurality of child nodes; and output the action identifier to the event map circuitry.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. An apparatus comprising:
a plurality of event reporting circuitries that are each configured to store context data for one or more detected events, including an event identifier for each of the one or more detected events;
an event map circuitry configured to control one or more notification channels based on an input event identifier; and
an event summarization circuitry configured to:
receive event identifiers from a plurality of child nodes, wherein each child node is one of the plurality of event reporting circuitries or another event summarization circuitry configured to output an event identifier from one of the plurality of event reporting circuitries;
select a highest priority event identifier from a set of event identifiers currently output by the plurality of child nodes;
output the selected event identifier to the event map circuitry; and
store a pointer to the child node that output the selected event identifier.

2. The apparatus of claim 1, comprising:
a processor core configured to execute instructions; and
a memory storing instructions that, when executed by the processor core, cause the processor core to:
load the pointer to the child node that output the selected event identifier that is stored by the event summarization circuitry; and
accessing, using the pointer, the child node that output the selected event identifier.

3. The apparatus of claim 2, wherein the event summarization circuitry is part of a tree including multiple levels of summarization nodes and the memory stores instructions that, when executed by the processor core, cause the processor core to:
iteratively access successive child nodes until one of the plurality of event reporting circuitries is accessed to load context data for an event corresponding to the selected event identifier.

4. The apparatus of claim 1, wherein the one or more notification channels includes a conductor connected between the event map circuitry and an interrupt controller.

5. The apparatus of claim 1, wherein the one or more notification channels includes an enable conductor connected between the event map circuitry and a hardware response circuitry configured to perform an operation in response to an event corresponding to the selected event identifier.

6. The apparatus of claim 1, wherein the event map circuitry is configurable by software to associate a list of one or more event identifier values with one of the one or more notification channels.

7. The apparatus of claim 1, wherein the event summarization circuitry comprises:
a history circuitry configured to store a temporally ordered list of event identifiers received from the plurality of child nodes.

8. The apparatus of claim 1, wherein the event summarization circuitry is configured to:
receive an action identifier associated with the selected event identifier from one of the plurality of child nodes; and
output the action identifier to the event map circuitry.

9. The apparatus of claim 1, wherein the event summarization circuitry is configured to:
store child identification data for the child node that output the selected event identifier.

10. The apparatus of claim 1, wherein at least one of the plurality of event reporting circuitries includes a race resolution circuitry to control updates to context data for events that it stores.

11. The apparatus of claim 1, wherein the one or more detected events are errors detected by components of a system on a chip.

12. A method comprising:
receiving event identifiers from a plurality of child nodes, wherein each child node is one of a plurality of event reporting circuitries or an event summarization circuitry configured to output an event identifier from one of the plurality of event reporting circuitries;
selecting a highest priority event identifier from a set of event identifiers currently output by the plurality of child nodes;
outputting the selected event identifier to an event map circuitry; and
storing a pointer to the child node that output the selected event identifier.

13. The method of claim 12, comprising:
loading the pointer to the child node that output the selected event identifier; and
access, using the pointer, the child node that output the selected event identifier.

14. The method of claim 13, comprising:
iteratively accessing successive child nodes until one of the plurality of event reporting circuitries is accessed to load context data for an event corresponding to the selected event identifier.

15. The method of claim 12, wherein the event map circuitry is configured to control one or more notification channels based on an input event identifier, and the one or more notification channels includes a conductor connected between the event map circuitry and an interrupt controller.

16. The method of claim 12, wherein the event map circuitry is configured to control one or more notification channels based on an input event identifier, and the one or more notification channels includes an enable conductor connected between the event map circuitry and a hardware response circuitry configured to perform an operation in response to an event corresponding to the selected event identifier.

17. The method of claim 12, comprising:
associating a list of one or more event identifier values with a notification channel.

18. The method of claim 12, comprising:
storing a temporally ordered list of event identifiers received from the plurality of child nodes in a history circuitry.

19. The method of claim 12, comprising:
storing a version number for the child node that output the selected event identifier.

20. A non-transitory computer readable medium comprising a circuit representation that, when processed by a computer, is used to program or manufacture an integrated circuit comprising:
a plurality of event reporting circuitries that are each configured to store context data for one or more detected events, including an event identifier for each of the one or more detected events;
an event map circuitry configured to control one or more notification channels based on an input event identifier; and
an event summarization circuitry configured to:
receive event identifiers from a plurality of child nodes, wherein each child node is one of the plurality of event reporting circuitries or another event summarization circuitry configured to output an event identifier from one of the plurality of event reporting circuitries;
select a highest priority event identifier from a set of event identifiers currently output by the plurality of child nodes;
output the selected event identifier to the event map circuitry; and
store a pointer to the child node that output the selected event identifier.
